(19) United States
(12) Patent Application Publication
(10) Pub. No.: US 2004/0202107 A1
(43) Pub. Date: Oct. 14, 2004

(54) Equipment and method for management of state information for data transmission in a telephone network

(76) Inventors: Michael Bensimon, Grenoble (FR); Nicolas Prunel, Grenoble (FR)

Correspondence Address: PERMAN & GREEN, 425 POST ROAD, FAIRFIELD, CT, 06824, US

(21) Appl. No.: 10/628,293

(22) Filed: Jul. 28, 2003

(30) Foreign Application Priority Data
Jul. 30, 2002 (FR) 0209688

(51) Int. Cl. H04L 12/26

(52) U.S. Cl. 370/229

(57) ABSTRACT

This invention relates to a method for data transmission in a telephone data transmission network (1), from a server (3) to at least one network terminal (11), characterised by the fact that:

the server (3) acquires state information for the network (1) from traffic transmission devices on the network (1), the network (1) determining state information specific to the telephone activity of the terminal (11) and providing it as network state information, and

the server (3) compares network state information with at least one predetermined state criterion for the network (1), to delay transmission of data as long as the state of the network (1) does not satisfy at least one state criterion.

This invention relates to data transmission in a telephone data transmission network.

Telephone networks initially offered a voice transmission service associated with a data transmission service offering only a very limited speed. For example, like the Minitel service.

Radiotelephone networks then appeared, like the GSM network, and similarly offered a low speed data transmission channel. Users could thus send SMS short messages.

With the development of the Internet computer network, it quickly became clear that telephone networks could not satisfy the needs of subscribers in terms of passband and protocol types for high speed data exchanges, in other words to quickly transmit large files.

In the case of radio networks, the development of the GPRS network is intended to make an improvement because it offers a broader passband while waiting for the UMTS network.

Data transmissions in networks are now made in packet mode, so that terminals can remain connected to the network at all times, since they do not immobilize resources if no packets are being transmitted. Terminals remain virtually connected and can thus be reached without delay.

This possibility of fast access to terminals is a means of offering new services, for example automatic supply of information data from specialized servers. For example, a terminal user can thus make a subscription to a service supplier informing him immediately about a given type of event, for example sports or political events, or if a share price is “exceeded”. This service type is called a “push” service, due to the fact that information is automatically “pushed” to the terminal without the user needing to make a specific request for it, in other words without needing to “pull” it from the server. Thus a “push” type of operation prevents unnecessary requests by the user to determine whether or not there is any information waiting in the server. The terminal thus automatically receives information data, in masked mode for the user, and then notifies the user afterwards.

This type of request makes the system easier to use, and also avoids network congestion. However, since the server sends information packets at random times, without any cooperation or synchronization with the receiving terminal, this information data transmission sometimes occurs when the terminal is communicating with a correspondent by exchanging data packets. The terminal traffic is thus temporarily increased while information is being received from the server, which can degrade the service quality.

This degradation may appear as a result of collisions between applications and fluctuations reducing the flow of data swapped with the correspondent, in other words an increase in loading times. This causes a clearly perceptible hindrance for large data files exchanged with the correspondent or received from the server. The same problem would occur if the terminal cyclically and automatically called the server to ask if there are any data to be “pulled”.

Furthermore, the terminal may be temporarily isolated from the network because the user has out it on standby, or in the case of a radiotelephone network, if he has moved out of covered radio areas. In these cases, server calls will unnecessarily congest the network and will consume resources.

The purpose of this invention is to avoid disturbing network traffic, and particularly but not exclusively terminal traffic, in the context of an automatic data swap at random times between a terminal and a server, in masked mode for the terminal user.

The invention achieves this firstly by using a data transmission method in a telephone data transmission network, from a server to at least one network terminal, characterised by the fact that:

the server acquires network state information from network traffic transmission devices, the network determining state of information specific to the telephone activity of the terminal and providing it as network state information, and

the server compares network state information with at least one predetermined network state criterion, to delay transmission of data to the terminal as long as the network state does not satisfy at least one state criterion.

Note that a terminal may refer to any type of equipment connected to the network.

Thus, although a terminal does not provide the server with any information about its accessibility and occupancy state which would enable the server to send at the most opportune moments, the network itself provides this type of information and therefore allows the server to synchronize itself such that the server traffic is sent in phase opposition with the terminal traffic, or at least at its traffic peaks, and that this transmission takes place at the right time, when it is connected to the network. In short, the server can thus only send when the terminal has the necessary network resources for reception, in terms of the passband or processing power. Similarly, the network can notify the server that its infrastructure is close to saturation, and thus control smoothing of its traffic while ordering the server to delay its transmission.

It may be considered that the invention consists of functionally integrating the server in a semaphore signalling network, “covering” or doubling the transmission part of the network concerned, to be able to use the required information about the state of the telephone network. It will be remembered that one of the functions of a semaphore signalling network is to detect the occupancy state of a called terminal and to make it ring, a voice communication channel only being set up if the called party answers. This thus avoids useless allocations of network resources. Conventionally, semaphore networks are of the closed type and information carried on them is reserved exclusively for network hosts.

Note that the invention also covers variants of the “push” technique. The problem that this invention was intended to solve relates to the fact that the server causes a traffic increase at the terminal. However, data emitted by the server may have only an indirect effect on the traffic, since they are only simple remote controls ordering the terminal to connect to another correspondent (server or other) to swap data in one or another direction. In short, the domain of the invention is not limited to “push” mode.

The invention may advantageously be used by means of a manager acquiring state information and retransmitting it to the server. The local or distributed manager may be a network server or may be integrated or associated with the user server.

In one embodiment of the method, the network acquires at least part of the state information from transmission devices, which are network switching centres.

As a variant or a complement, the network acquires at least part of the state information using traffic monitoring sensors placed on network communication feeders, and particularly at the various following interface:

Air (or Um) interfaces, each located between a mobile station (MS) and the base station (BTS) of the geographic unit in which this mobile station is located,

Abis interfaces, each located between a base station (BTS) and the corresponding base station controller (BSC),

A interfaces, each located between a base station controller (BSC) and the corresponding mobile switching centre (MSC),

“CCITT telephone No. 7” interfaces (SUP, TUP, SSUTR2), each located between a mobile switching centre (MSC) and a transit centre,

MAP (Mobile Application Part) interfaces, each located between a mobile switching centre (MSC) and a specialized database (HLR, VLR, AuC, EIR).

The server or the manager may be designed to request required state information from the network, and in particular in return to use the network to control the supply of information about the refreshment of state information, for example by sending terminal activation stimuli to the network. The stimuli set up a context for a new data link in the network, which is detected to refresh network state information specific to the terminal.

In this case, stimuli activate a terminal application according to a first mode, for example a SIM Toolkit application.

According to a second mode, the stimuli firstly reach a network switching centre and order it to transform them into a transmitted terminal activation message, notifying it that it must call a centre to retrieve data.

It can be seen that the invention is perfectly but not limitatively applicable to cellular networks, for example GPRS or UMTS, but that it is also applicable to radio networks formed by a constellation of satellites.

The invention also relates to a telephone network state information manager for implementation of the method according to the invention, comprising management means arranged to receive network state information and to retransmit them to information data servers.

The invention will be better understood after reading the following description of a network in which the method according to the invention was used with reference to the appended drawings, wherein:

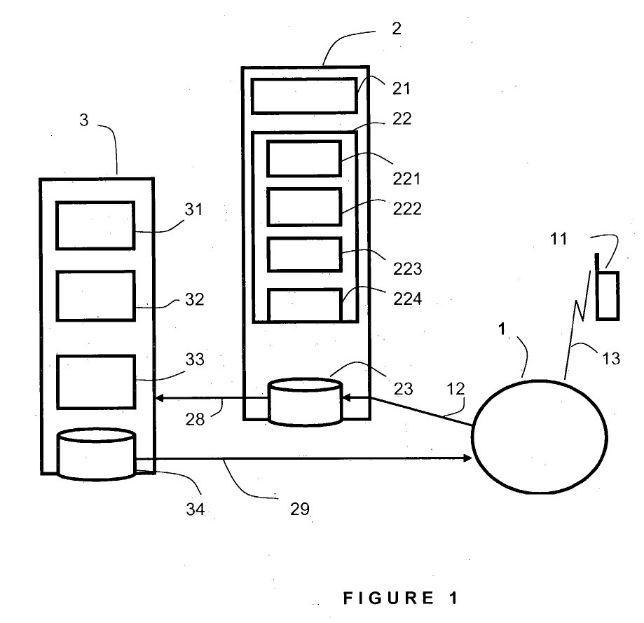

FIG. 1 is a very diagrammatic view showing a radiotelephony network; in this case the GPRS cellular network, in the example connected through a network state information manager to an information data supply server in “push” mode, using the method according to the invention,

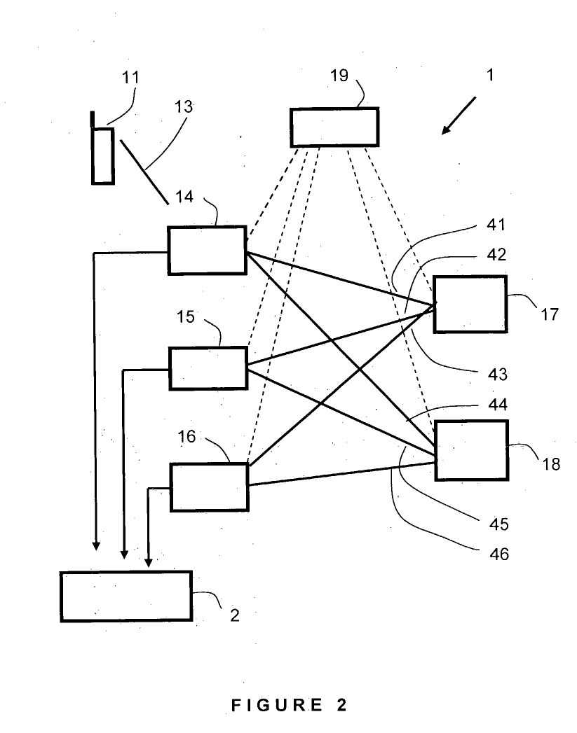

FIG. 2 shows the network in FIG. 1 and illustrates a first mode of the method, for retrieving network state information from network switching centres,

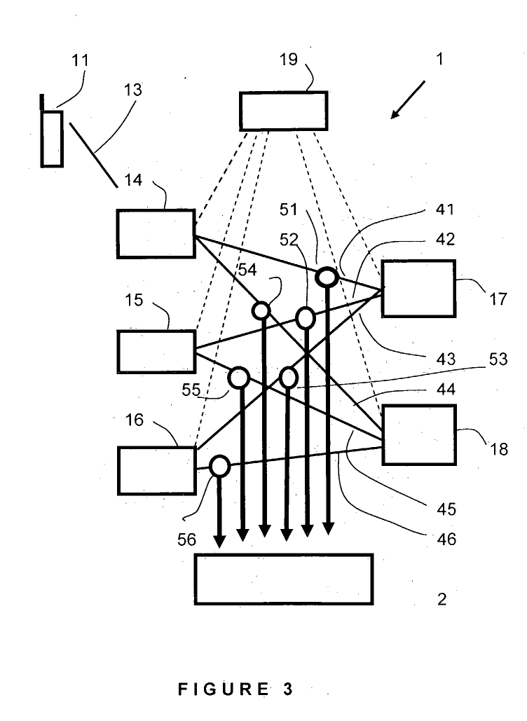

FIG. 3 illustrates a second mode of the method, for retrieving network state information using sensors located on network feeders (interfaces),

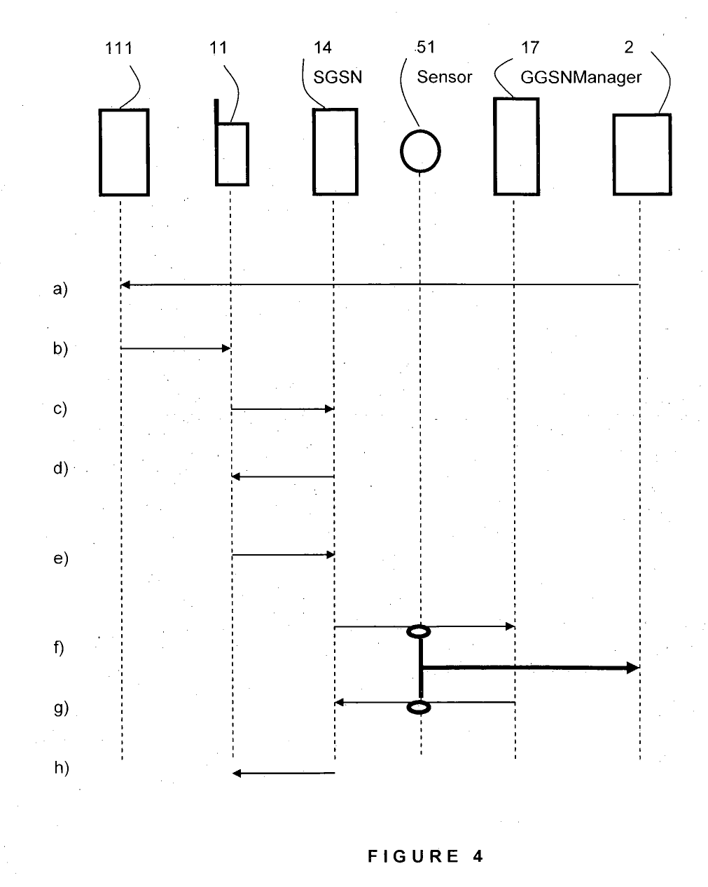

FIG. 4 is a signal exchange diagram illustrating a method for refreshment of network state information, triggered by sending terminal activation stimuli from the manager, which in a first embodiment activate an application in the terminal to make it set up a link in order to analyse the characteristics of the corresponding traffic, and

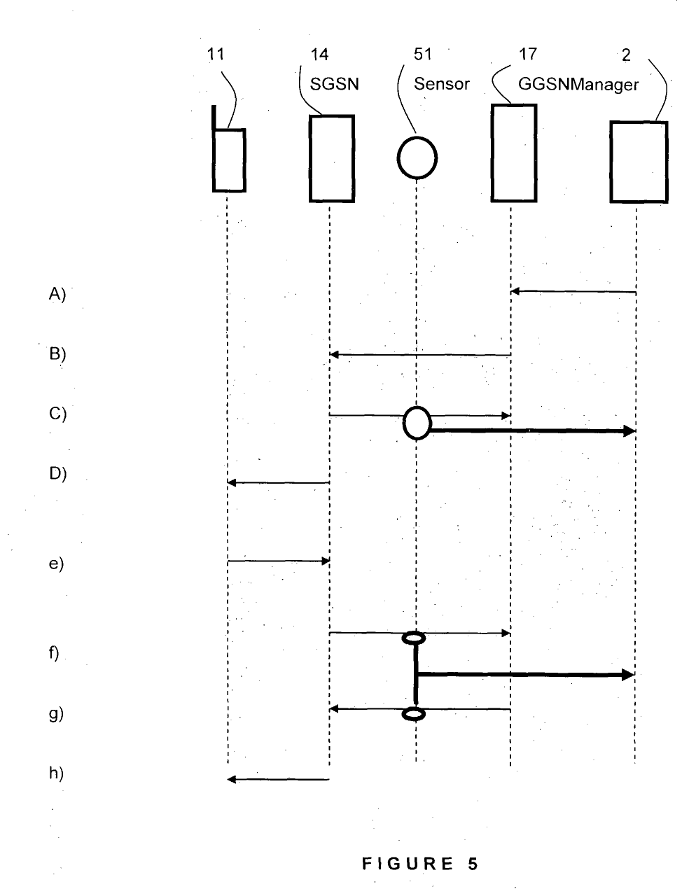

FIG. 5 is a diagram similar to the diagram in FIG. 4, illustrating a second embodiment of the above refreshment method corresponding to stimuli ordering sending a message to a target terminal in network switching centres, to notify it that data addressed to it are waiting.

We will now describe the infrastructure for implementing the invention and explain how it operates, and we will then describe the above two methods one after the other in each of their two modes.

FIG. 1 shows a telephone data transmission network 1, and more precisely in this example a radiotelephone network that is cellular in this case, namely the GPRS network that is based on the GSM network infrastructure.

The choice of a radio type network in this example is due to the fact that in particular it describes the relatively frequent case of a unlocated mobile radio terminal, in other words temporarily not attached to the network 1 (idle), because it is in a shadow area or by deliberate action taken by the user to switch the power supply off. However, a similar case to switching the power supply off occurs in a wire network, for example in the presence of an S0 type bus on which several terminals may be individually connected or disconnected or switched off.

A data server 3 is connected to the network 1 to access mobile terminals 11, only one of which is shown. The server 3 comprises a system unit 31 controlled by software for a memory 32, a table 33 of state criteria (at least one) for the network 1, accessible through software for the memory 32 and a send data memory 34.

In this example, the server 3 is connected to the network 1 through an interface manager or front end manager 2 for management of state information for the network 1, in other words server 3 acquires state information in this case through the manager 2. The manager 2 comprises a system unit 21 controlled by software of a memory 22, and a memory 23 for state data for network 1. For convenience, in this case the software in the memory has the same reference as the memory, but is shown between parentheses. The software (22) includes the following:

software 221 for interrogation about the state of the network 1,

activation software 222 laid out to run state information refreshment stimuli in the network 1,

software 223 for combining state information about the network 1, in order to provide the server 3 with summary state data, and

software 224 for integrating network state information with time, in order to provide the server 3 with summary state data.

A working memory, not shown, in the system unit 21 stores the various commands or requests or equivalent signalling signals exchanged with the network 1 and with the server 3. Hardware and software communication interface means for the manager 2 and the server 3 are not drawn and described herein, since the invention is not specifically applicable to them.

The presence of the manager 2 in this example has the advantage of centralising management tasks in order to minimise modifications for this purpose in the network 1. This also enables work in masked time to swap data with the network 1.

Information data from server 3 may consist of any type of file such as text, fax, sound signals or images. Nevertheless, as we will see later, their nature may have a more or less disturbing influence on the network 1 and particularly at terminal 11, due to the data volume involved and the protocol used, that could consume too many processing resources.

With regard to the network 1, the manager 2 may be functionally considered in two different ways. Firstly, the manager 2 may be considered as being an interface associated with the server 3, an interface that has rights with regard to network 1 to interrogate it about its state. Furthermore, and although drawn outside the network 1, the manager 2 may be considered as functionally forming part of the network 1, as a specialised server to answer the server 3. The same is true for an audio link 13 connecting the terminal 11 to the network 1.

The server 3 is actually connected to the network 1 through two types of links. A first type of link 12, 28, mainly an output link from the network 1, passes through the manager 2 as shown and concerns the supply of information about the state of network 1 and supplied by the network, to the server 3, to implement the method according to the invention. This information is equivalent (possibly after processing) to service signals, starting from which the server 3 generates commands regulating an information data flow automatically transmitted in “push” mode towards terminals 11, on a second type of link 29 mainly input to network 1. Therefore the second type of link 29 is slaved by the first type of link 28, that acts as a semaphore link managing the incident flow in network 1 and thus minimising contentions. On this subject, note that the manager 2 can also be used by the various centres of network 1 for any off-line data swaps, for example invoicing files.

Therefore, it can be considered that the network 1 itself uses information that it supplies on the outgoing link 12, 28, to control the traffic volume that it receives through the loopback link 29. Therefore, the incoming link 29 was deliberately drawn to avoid passing through the manager 2, which only acts on the input side (28) of the link, although there is no reason why the link 29 should not also pass through the manager 2. The logical data links 28 and 29 may be set up on any type of transmission support, for example a radio channel or they may be wire links and in this case may be carried on the same physical support, such as a twisted pair, coaxial, optical fibre.

As described above, the concept of the invention is to provide the server 3 with information about the state of the network 1, including the state of information about links such as link 13 of terminal 11.

To achieve this:

server 3 acquires state information about network 1, originating from traffic transmission devices (14 to 18, FIG. 2) of network 1, and

server 3 compares state information for network 1 with at least one predetermined state criterion for network 1, from table 33, to delay the data transmission as long as the state of network 1 does not satisfy at least one state criterion.

The state information may relate to network 1 as a whole, as already mentioned, or to some identified terminals 11, for example previously designated by the server 3. State information may thus apply to load levels at various switching centres 14 to 18 of the network 1, the busy state of the link 13 of terminal 11, the intensity of its traffic if any, or the type(s) of the active protocol(s) on the link 13, for example HTTP, FTP, which provides information about the processing load factor on a communication processor for the terminal 11 and therefore its ability to also receive the flow of information data waiting in the server 3. For example, the FTP protocol monopolises all resources of the terminal 11, and therefore a data transmission from server 3 during this period will be harmful. The indication that the target terminal 11 is using the FTP protocol in the state information supplied to server 3, is a criterion for saturation of the terminal 11 which, by viewing table 33, prohibits data from being sent from the server 3. Therefore, the sending time is delayed until a later moment when the FTP protocol will be indicated as not being used provided that other required criteria are also satisfied, for example the fact that the terminal 11 is reachable or that the traffic saturation level on network 1 does not exceed a high threshold.

Table 33 also contains at least one criterion for regulation of traffic that could be injected into the network 1. Preferably, there are several such criteria, used by the software (32).

The software (32) compares “values” of the received state information with corresponding values in table 33 to decide to send waiting data immediately, or to delay sending it if at least one of the criteria is not satisfied. A criterion for such a decision may sometimes be the result of a combination of several types of raw or primary information that are thus weighted.

Table 33 could even at least partially replace the software 32 in forming a decision table by itself, in other words a sort of combinational logic of the FPLA type (programmable logic network), that receives various types of state information and combines these data according to predetermined rules to directly output permission to send data waiting in memory 34.

Thus, among other features, the network 1 can determine state information specific to the telephone activity of the terminal 11 and provide it as state information about the network 1. Thus, the network 1 determines at least one of the following types of information, as information specific to terminal 11:

traffic load state at an SGSN switching centre (FIG. 2) to which the terminal 11 is attached,

accessibility state of terminal 11 (Idle/Ready/Standby),

busy state of the terminal 11, particularly typical swapping of data traffic, and if applicable the type of protocol used (FTP, HTTP, etc.),

up flow from terminal 11 to the SGSN switching centre or attachment centre,

down flow from the SGSN switching centre to the terminal 11,

service quality allocated to the user of the terminal 11.

The network 1 can monitor changes to state information and automatically send a state change notification to server 3 and therefore in this case to the manager 2, requiring that previously acquired state information should be refreshed. In particular, the network 1 can spontaneously notify the manager 2 that modified state information has been updated.

The manager 2 thus receives state information from the network 1 and stores it in memory 23, in order to forward it afterwards to server 3, either when requested or spontaneously.

The management means 21, 22 and 23 thus enable the manager 2 to receive state information from network 1 and forward it to information data servers 3, the software 221 being used to interrogate the network 1 about its state.

The activation software 222 can also send state information refreshment stimuli to the network 1, as explained later.

In order to make a better presentation of state information, the software 223 combines state information for network 1, in order to produce summary state data, for example in the form of values of an availability index for terminal 11. The index has five levels, in this case corresponding to a terminal:

index 0: reachable but not active,

index 1: the terminal is reachable but is weak, use of resources (instantaneous message service),

index 2: reachable but with limited network resources,

index 3: reachable with useable and fully used network resources (FTP, etc.),

index 4: not reachable.

For the same purpose, the software 224 integrates state information for the network 1 with respect to time, type by type, to provide the server 3 with summary state data for the network 1.

The two embodiments of the method for acquisition or extraction of state information for network 1 will now be described.

First embodiment of the method for acquisition of state information for network 1 (FIG. 2).

The network 1 can acquire at least some state information, for example the “GPRS presence” of a terminal 11, by interrogation of switching centres of a network 1, adapted for this purpose. In FIG. 2, references 14, 15 and 16 designate switching terminal centres, or cellular attachment centres, called SGSN (GPRS service nodes) managing the terminals 11 of a cell specific to each attachment centre. References 17 and 18 denote GGSN node centres (GPRS gateway nodes) connected to SGSN centres 14 to 16 respectively, and federating them through high speed communication feeders 41, 42, 43 and 44, 45, 46 on different types of physical supports. Reference 19 denotes an HLR management centre for localising terminals 11 between different cells.

In this case, the manager 2 queries the most relevant, centres mentioned above, or receives spontaneous emissions from them.

The network 1 acquires at least some state information from network switching centres, in this case the SGSN attachment centres 14, 15, 16 of terminals 11. Each SGSN centre 14, 15, 16 of the network 1 stores at least one of the following types of state information locally and sends it to the server 3, therefore in this case towards the manager 2, for each terminal 11 attached to one of the centres 14, 15, 16:

terminal unique identifier (IMSI, MSISDN),

terminal accessibility state: “MM State”: idle, therefore not reachable, standby, ready—and therefore reachable in the latter two cases,

terminal location (by definition of the routing area), the number of the current cell (cell-ID) when the terminal is in “READY” mode, or the last known cell if the terminal is in standby mode or is idle,

typical idle time of the terminal (CellIdentity-Age) or time since the last data transfer,

number of PDP (Packet Data Protocol) contexts, in other words the number of logical links,

state of each PDP context (Ready or Idle),

allocated PDP address(es),

allocated quality level,

up traffic,

down traffic, possibly in the form of “input side” information that can be used to deduce the up and down traffic, like “Send N-PDU number of protocol data units, “Send N-PDU Number” and “Receive N-PDU Number”.

In one form of operation, the centres 14 to 16 monitor the current state of state information to compare it with state information previously stored locally, so that if the state changes, information stored locally can be refreshed and can itself trigger sending current state information to the server 3, in this case through the manager 2.

The following events should be monitored at centres 14 to 16 and can induce state changes. Note that this list is not exhaustive,

change of the accessibility state of terminal 11, in other words its GPRS state,

attachment of one terminal to another centre 14 to 16,

change the routing area,

start, interrupt or end a data transfer,

renegotiation of a QoS (Quality of Service) level,

activate or deactivate a link context.

Information stored locally in a centre 14 to 16 can still be transmitted to the server 3 following a request by the manager 2, possibly repeating the same request output from the server 3.

In the second embodiment of the method for acquisition of state information about the network 1 (FIG. 3), the network 1 acquires at least some of the state information by means of traffic monitoring sensors 51 to 56 placed on the corresponding communication feeders 41 to 46 in network 1, connecting GGSN node centres 17, 18 to the various attachment centres 14 to 16. The monitored feeders may be the link part of feeders 41 to 46, or if this is impossible (optical fibres) or to facilitate matters, their start or end termination points, or their corresponding interconnections in GGSN node centres 17 or 18 or other routers. Therefore, it is a real time analysis of signalling or data fields in signalling and data messages passing through the GPRS federating network. Thus, this type of second mode based on sensors 51 to 56 avoids the need for modifications in centres 14 to 18 of the network 1. The fact that, as designed, the outputs from sensors 51 to 56 are attached to manager 2, is only schematic and in practice uses the channels in network 1.

Sensors 51 to 56 analyse message signalling fields passing on feeders 41 to 46 to extract at least some state information about terminals 11, if they are active. For example, the packet headers according to the GTP protocol (GPRS Tunnel Protocol) are used to identify the terminals 11 using their unique IMSI identification number in a TID field. Sensors 51 to 56 analyse at least one of the following signals from terminal 11:

request to create a link context, using a Create PDP Context Request/Response command,

request to update a link context, using an Update PDP Context Request/Response command,

request to delete a link context, using a Delete PDP Context Request/Response,

request for a PDU notification, using a PDU Notification Request/Response command,

request to send network routing information, using a Send Routing Information for GPRS Request/Response command,

request to note that a terminal is reachable again, using a Note MS GPRS Present Request/Response command,

identification request, using an Identification Request/Response command, and

request for SGSN context, using an SGSN context Request/Response/Acknowledge command.

Since the various messages are transmitted using different protocols, sensors 51 to 56 identify the protocol(s) used by one or more logical links of the terminal 11.

Therefore, an analysis of GTP signalling messages provides information about the GPRS presence of a subscriber, his addressing (IP, X25) and the QoS that he receives. Essentially, the GTP protocol relates to management of PDP contexts and GPRS states (Idle/Ready/Standby) are deduced from messages related to PDP contexts. Thus, when a PDP context is active, a user can be reachable (Ready state). The fact that a user becomes reachable is marked by reception of a “Note MS GPRS Present Request” message from the HLR to the GGSN through the MAG/GTP gateway and also by inter SGSN exchanges when the GPRS is hosted on a new SGSN.

We will now explain the refreshment of state information for the network 1.

The manager 2 may ask the network 1 for the required state information, following a request by the server 3 or an independent decision. The manager 2 may detect that the state information that it received and that is stored in memory 23 with time dating data, are obsolete after a certain stored data time limit, detected by comparison with the current time.

The manager 2 can also receive a request sent by the server 3 for state information for network 1 that is not available in memory 23, and is possibly not available in the network 1 due to lack of activity on the link 13 of the terminal 11 and therefore also non-existent in feeders 41 to 46 for the terminal 11. Refreshment will then only be ordered after the manager 2 has received a request for state information from the server 3.

The manager 2 then controls refreshment of state information in the network 1, in other words refreshment of previously received state information or the supply of state information in addition to what was previously received.

The manager 2 can monitor availability of state information in network 1 and it controls refreshment if some state information is not available, for example due to lack of traffic from the terminal 11 as mentioned above.

State information is refreshed by sending activation stimuli for terminal 11 in network 1, to activate it to make it set up a context for a new PDP data link in the network 1 and to detect the PDP link context to refresh network state information specific to the terminal 11. For example, the location of terminal 11 in a cell (Cell ID) instead of a more global positioning within a routing area. The following two embodiments of the process described above are possible.

First embodiment of the method for refreshment of state information.

According to the first embodiment, the stimuli activate an application of the terminal 11. This could be a SIM Toolkit application or any other client application in the terminal 11. The terminal 11 attached to the network 1 as seen from the GSM, is also called using a sort of “paging”, for example using an SMS, SMSCB, USSD or other type of message.

This application opens a logical link on the radio link 13 by sending an “OPEN CHANNEL” command to the terminal 11, which leads to the creation of a PDP link context which may be detected and examined by the centres 14 to 18 or by sensors 51 to 56, and thus supply refreshed state information to the manager 2.

If the terminal 11 is in the “Idle” GPRS state, it attaches itself to the network 1 and thus becomes reachable. The terminal 11 then changes to the Ready state, and this causes the positioning information to be updated within the cell.

The newly created PDP context is then used to refresh state information such as the quality of service (QoS) level negotiated between the terminal 11 and the network 1, and the address of the terminal 11 and the terminal type, such as IP, X25.

The manager 2 may send application deactivation stimuli later, for example using a “CLOSE CHANNEL” command to deactivate the PDP context, if there is no timeout control for deactivating the considered application.

FIG. 4 illustrates this first embodiment.

This example shows the GSM application called the SIM Toolkit 111, the mobile terminal (MS) 11, the SGSN centre 14, the sensor 51 on the feeder 41, the GGSN node centre 17 and the manager 2, in this order working from left to right in the figure.

The eight steps shown are identified from a) to h). In a first step a), the manager 2 sends a call (paging) to the SIM Toolkit application 111, to trigger it or start an “Update Information Request” message. In a second step b), the application 111 responds by sending an “STK OPEN CHANNEL” message to the terminal 11. In a third step c), the terminal 11 then sends a “GMM Attach Request” to the SGSN 14, which in a fourth step d) replies with a “GMM Attach Response” message. In a fifth step e), the terminal 11 responds by sending an “SM Activate PDP Context Request” message. The GGSN 17 then sends this request along the feeder 41 in a sixth step f), and the sensor 51 detects it on the feeder by a “GTP Create PDP Context Request” message containing an IMSI number, a PDP address and other information making up the required state information. The GGSN centre 17 responds in a seventh step g) by sending a “GTP Create Context Response” message containing an allocated quality of service (QoS) level and other state information. The sensor 51 collects the above state information and sends it to the manager 2 in an “Update Information Request” refreshment message. The SGSN centre 14 then sends to the terminal 11 an “SM Activate PDP Context Response” message defining the required context, in an eighth step h).

Second embodiment of the state information refreshment method.

According to the second embodiment, the command to activate a terminal application 11 is made indirectly by activating a notification function existing in network 1.

The stimuli firstly reach a switching centre or an attachment centre to the network 1, in this case a GGSN node centre 17, 18, and then order it to transform the stimuli into a message to activate the terminal 11 which is sent to it and notifies it that it should call the GGSN node centre 17, 18 to retrieve the data.

FIG. 5 illustrates this second embodiment. Thus, in a first step A), the manager 2 sends an “Update Information request” message to the node centre GGSN 17, using the IMSI number of the terminal 11. In a second step B), the GGSN node centre 17 sends a “GTP PDU Notification Request” message containing the IMSI number, a PDP address and other information, to the SGSN cell centre 14 to which the terminal 11 is attached. In a third step C), the SGSN cell centre 14 responds with a “GTP PDU Notification Response” message in return. Sensor 51 detects and analyses this message that collects information about the IMSI number and extracts information about whether or not the terminal 11 is present in the cell at the SGSN 14, and this information is forwarded to the manager 2. If the terminal is reachable, the SGSN attachment centre 14 sends an “SM Request PDP Context Activation” message in a fourth step D). The next steps five to eight are similar to steps e) to h) in FIG. 4.

In general, we have mentioned use of the infrastructure to determine the most suitable moment to transmit data to the client. However, we would also mention other uses of the infrastructure, for example:

adaptation of the “bearer” (CSD, GPRS, SMS); for example, if a supplier of a “push” service realises that the GPRS network is congested, he can decide to use the “push” technique through an SMS;

adaptation to the contents format; for example, if the user is not busy but his SGSN is highly loaded, he can adapt the contents to be sent (deletion of images, change from the HTML format to the WML format) in order to limit loading times of the contents for the user.

Persons skilled in the art will realise that many different possible embodiments of this invention are possible in other specific forms without going outside the scope of the invention as claimed. Consequently, the embodiments described herein must be considered solely as illustrations, but they can be modified within the domain defined by the scope of the appended claims, and the invention must not be limited to the details mentioned above.

What is claimed is:

1. Method for data transmission in a telephone data transmission network, from a server to at least one network terminal, characterised by the fact that:
the server acquires state information for the network from traffic transmission devices on the network, the network determining state information specific to the telephone activity of the terminal and providing it as network state information, and
the server compares network state information with at least one predetermined criterion for the state of the network, to delay the transmission of data to the terminal as long as the state of the network does not satisfy at least one state criterion.

2. Method according to claim 1, in which the network determines at least one of the following types of information, as information specific to terminal:
traffic load state at a switching centre to which the terminal is attached,
accessibility state of the terminal,
busy state of the terminal,
up flow from the terminal to the switching centre,
down flow from the switching centre to the terminal,
service quality allocated to the terminal.

3. Method according to claim 1, in which the network monitors changes to state information and automatically sends a state change notification to the server to request refreshment of previously acquired state information.

4. Method according to claim 3, in which the network notifies the need for a transmission to refresh state information that has changed.

5. Method according to claim 1, in which the server acquires state information through a state information manager.

6. Method according to claim 5, in which the manager receives and stores state information from the network.

7. Method according to claim 1, in which the network acquires at least some state information from network switching centres.

8. Method according to claim 7, in which each switching centre on the network stores at least one of the following types of state information locally and sends it to the server, for each terminal attached to the centre:
terminal unique identifier (IMSI, MSISDN),
terminal accessibility state,
terminal location,
time since the last data transfer,
number of PDP contexts,
allocated address,
allocated quality level,
up traffic,
down traffic.

9. Method according to claim 8, in which the centres monitor the current state of state information to compare it with the previous state information kept in local storage, so that when a state change event occurs, the locally stored information can be updated and current state information can be sent to the server.

10. Method according to claim 9, in which the centres monitor the appearance of at least one of the following types of events:
change of the accessibility state of the terminal,
attachment to another centre,
change the routing area,
start, interrupt or end a data transfer,
renegotiation of a quality level,
activate or deactivate a link context.

11. Method according to claim 8, in which information stored locally in a centre is transmitted to the server on request.

12. Method according to claim 1, in which the network acquires at least part of the state information through traffic monitoring sensors positioned on the communication feeders of the network.

13. Method according to claim 12, in which the sensors analyse signal fields of messages passing on communication feeders to extract at least some state information about the terminal.

14. Method according to claim 13, in which the sensors analyse at least one of the following signals:
request to create a link context,
request to update a link context,
request to delete a link context,
request to notify PDU,
request to send network routing information,
request to note that a terminal can once again be reached,
identification request, and
request for SGSN context.

15. Method according to claim 13, in which the various messages are sent using various protocols, and the sensors identify which protocol is used.

16. Method according to claim 5, in which the manager requests the required state information from the network.

17. Method according to claim 16, in which the manager sends an order in the network that information necessary to refresh the previously received state information should be returned.

18. Method according to claim 16, in which the manager monitors if state information is available in the network and orders that the information should be refreshed if some state information is missing.

19. Method according to claim 17, in which refreshment is not ordered until the manager has received a state information request from the server.

20. Method according to claim 19, in which the manager determines a storage duration for the information available to him and does not order refreshment unless the storage duration exceeds and expiration threshold.

21. Method according to claim 16, in which refreshment of the state information is ordered by sending activation stimuli to the terminal, through the network.

22. Method according to claim 21, in which the stimuli are sent to the terminal to activate it so that a context for a new data link can be set up in the network, and to detect the link context to refresh network state information specific to the terminal.

23. Method according to claim 22, in which the stimuli activate an application on the terminal.

24. Method according to claim 23, in which the stimuli activate a SIM Toolkit application.

25. Method according to claim 23, in which the application deactivation stimuli are sent later.

26. Method according to claim 22, in which the stimuli firstly reach a switching centre of the network and order it to transform them into a activation message sent from the terminal, notifying it that it should call a centre to recover data on this centre.

27. Method according to claim 1, in which the server is functionally integrated into a semaphore signalling network managing the telephone network.

28. Method according to claim 1, used in a radio network.

29. State information manager for a telephone network to use the process according to claim 1, comprising management means designed to receive state information from the network and to forward it to information data servers.

30. Manager according to claim 29, comprising means of making queries about the network state.

31. Manager according to claim 30, comprising activation means designed to send stimuli for the refreshment of state information in the network.

32. Manager according to claim 29, comprising means of combining network state information, to provide network state summary data.

33. Manager according to claim 29, comprising means of integrating network state information with respect to time, to supply summary data about the state of the network.
